(19) United States
(12) Patent Application Publication
(10) Pub. No.: US 2013/0300366 A1
(43) Pub. Date: Nov. 14, 2013

(54) CHARGER

(71) Applicant: QIN-XIANG LIU, Dong-Guan (CN)

(72) Inventor: QIN-XIANG LIU, Dong-Guan (CN)

(73) Assignee: Cheng Uei Precision Industry Co., LTD., New Taipei City (TW)

(21) Appl. No.: 13/468,407

(22) Filed: May 10, 2012

(51) Int. Cl. H02J 7/02

(52) U.S. Cl. 320/111

(57) ABSTRACT

A charger includes a charging body having a base body, two insertion pins apart assembled to a front end of the base body, and at least one USB port equipped in a rear end of the base body. A power plug includes a plug part, a socket part mounted to the plug part and defining two inserting slots, and two electrical terminals located between the socket part and the plug part and each having a pair of contact portions. The plug part has a group of power pins of which one end electrically connects with the electrical terminals and the other end projects outward for plugging in a wall socket. The power plug can be removably attached to the charging body by means of plugging the insertion pins into the corresponding inserting slots to electrically clamp the insertion pin between the contact portions of the corresponding electrical terminal respectively.

### BACKGROUND OF THE INVENTION

1. Field of the Invention

The present invention relates to a charger, and more particularly to a charger with a power plug.

2. The Related Art

With the development of technology, all kinds of different types of chargers came with the tide of fashion. A traditional charger generally includes a charging body and a stationary power plug integrally formed at one end of the charging body. The traditional charger only applies to a kind of wall socket on account of the stationary power plug. When people go abroad for business, leisure or other purposes, charging some carryon electronic products such as mobile phone, notebook and digital camera becomes a serious problem. Because, the wall sockets of different countries often have different standards and the traditional charger usually fails to match with the wall sockets of some countries. As a result, the users must buy other chargers when they want to use the carryon electronic products in foreign countries. It brings inconvenience for the users.

### SUMMARY OF THE INVENTION

Accordingly, an object of the present invention is to provide a charger. The charger includes a charging body having a base body and two insertion pins apart assembled to a front end of the base body and further projecting beyond the front end of the base body. At least one USB port is equipped in a rear end of the base body. A power plug includes a plug part, a socket part which is mounted to the plug part, and two electrical terminals which are located between the socket part and the plug part. The plug part has a group of power pins of which one end electrically connects with the electrical terminals and the other end projects outward for plugging in a wall socket. The socket part defines a pair of inserting slots corresponding to the insertion pins of the charging body for plugging the insertion pins of the charging body therein. Each electrical terminal has a pair of contact portions which are apart exposed in one of the inserting slots.

As described above, the charger includes the charging body and the power plug capable of being removably attached to the charging body by means of plugging the insertion pins of the charging body into the corresponding inserting slots of the socket part to electrically clamp the insertion pin between the contact portions of the corresponding electrical terminal respectively. So, when users go abroad, they just need to displace the power plugs of the corresponding countries to plug the charging body thereto so as to use the charging body in different countries. It brings convenience for the users.

### BRIEF DESCRIPTION OF THE DRAWINGS

The present invention will be apparent to those skilled in the art by reading the following description thereof, with reference to the attached drawings, in which:

FIG. 1 is an assembled perspective view of a charger in accordance with an embodiment of the present invention;

FIG. 2 is a perspective view of the charger showing that a charging body is separated from a power plug;

FIG. 3 is an exploded perspective view of the power plug shown in FIG. 2; and

FIG. 4 is another perspective view of a socket part of the power plug shown in FIG. 3.

### DETAILED DESCRIPTION OF THE EMBODIMENT

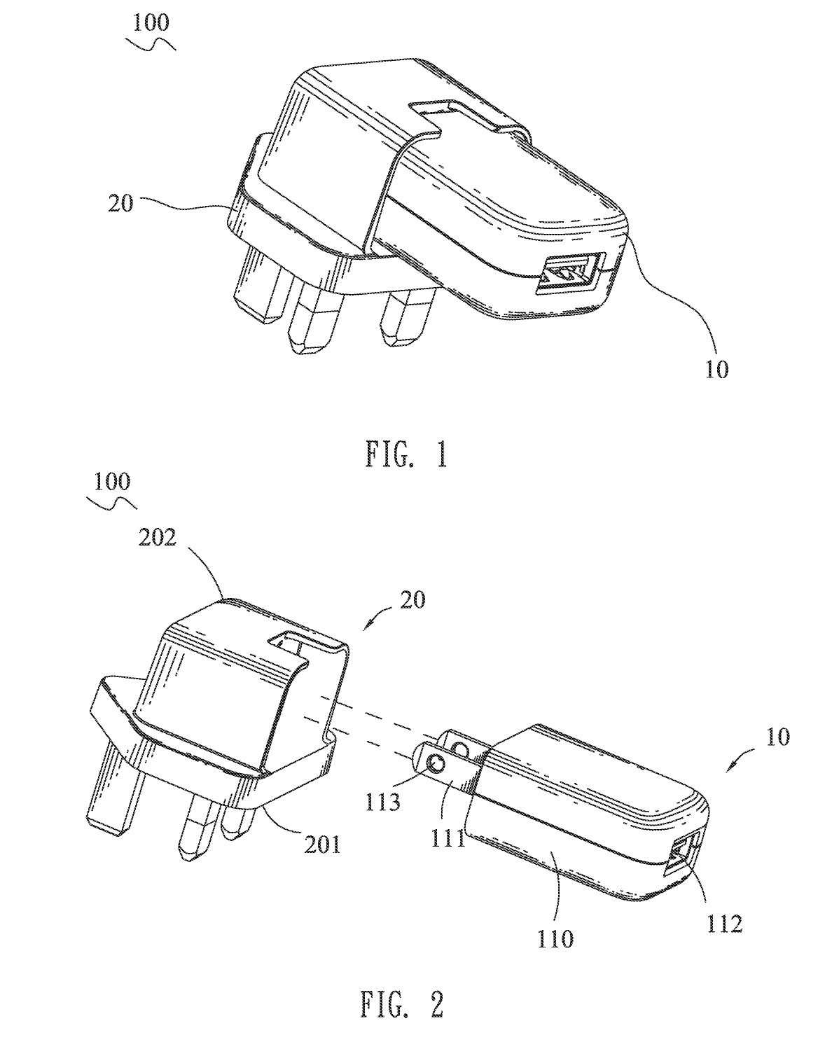

Referring to FIGS. 1-2, a charger 100 according to an embodiment of the present invention includes a charging body 10 and a power plug 20 capable of being removably attached to the charging body 10.

Referring to FIG. 2, the charging body 10 has a base body 110. Two insertion pins 111 are apart assembled to a front end of the base body 110 and further project beyond the front end of the base body 110. A fastening hole 113 is opened at a front end of each insertion pin 111. At least one USB port 112 is equipped in a rear end of the base body 110.

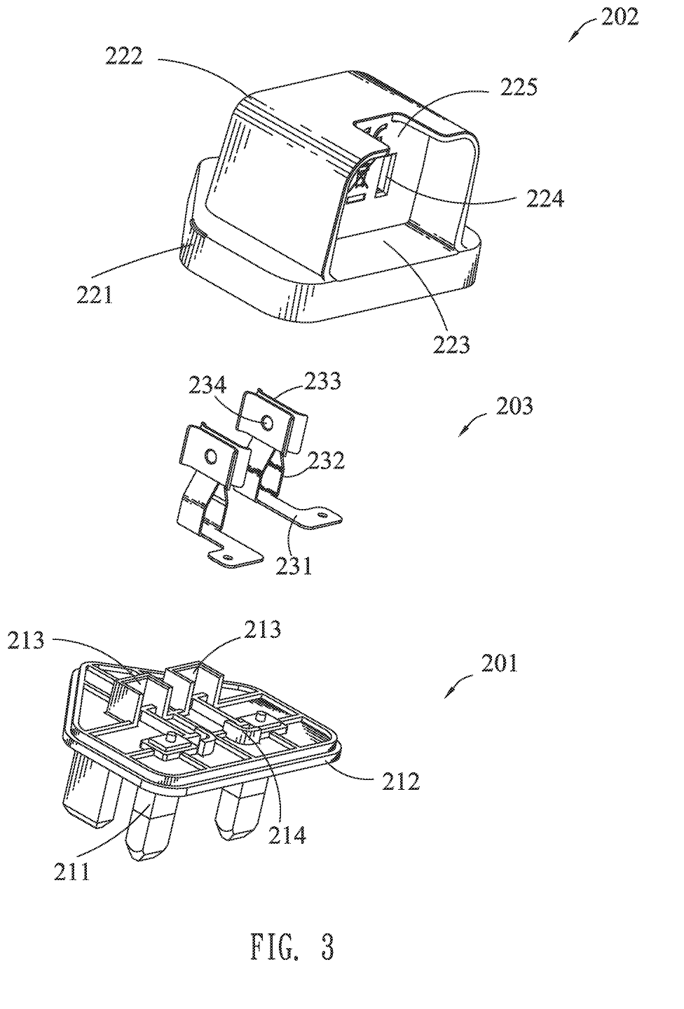

Referring to FIG. 2 and FIG. 3, the power plug 20 includes a plug part 201, a socket part 202 mounted to the plug part 201, and two electrical terminals 203 located between the socket part 202 and the plug part 201.

Referring to FIG. 3, the plug part 201 has a group of power pins 211 of which one end electrically connects with the electrical terminals 203 and the other end projects outward for plugging in a wall socket. The plug part 201 includes a fixing board 212 with a group of fastening grooves 213 apart defined on an inner side thereof. The inner side of the fixing board 212 further defines a group of blocking portions 214 arranged in accordance with the fastening grooves 213. In this embodiment, the power pins 211 are a group of British power pins. The power pins 211 are assembled to the fixing board 212 and further project beyond an outer side of the fixing board 212. The power pins 211 of the plug part 201 are designed and arranged according to the wall sockets of different countries so as to use the charging body 10 in different countries by means of displacing the power plug 20.

Referring to FIG. 3, the socket part 202 defines a pair of inserting slots 224 corresponding to the insertion pins 111 of the charging body 10 for plugging the insertion pins 111 of the charging body 10 therein. The socket part 202 includes a base pedestal 221 engaged with the plug part 201, and a socket body 222 protruding towards a direction opposite to the plug part 201 on the base pedestal 221. The inserting slots 224 are opened in a rear of the socket body 222. The interior of the socket body 222 defines two groups of restricting grooves 226 of which each group are spaced from each other and aligned with one of the inserting slots 224. A rear face of the socket body 222 is concaved forward to form a holding cavity 223 with the inserting slots 224 being opened in a front sidewall thereof. A front of the base body 110 of the charging body 10 is held in the holding cavity 224 when plugging the charging body 10 to the power plug 20. A rear end of a top wall of the holding cavity 224 is opened to form an opening 225 for the convenience of taking out the charging body 10 from the power plug 20.

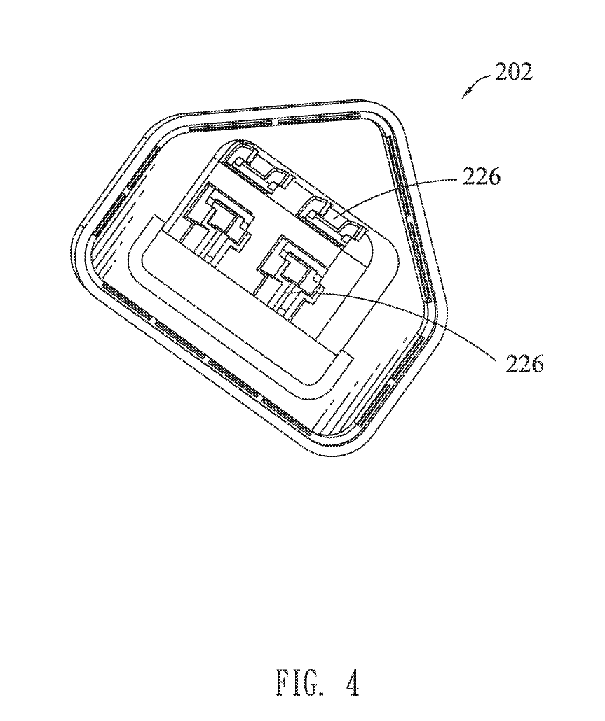

Referring to FIGS. 3-4, each of the electrical terminals 203 has a fixing plate 231 fixed on the plug part 201 and electrically connecting with the corresponding power pin 211. In detail, the fixing plate 231 is fixed on the inner side of the fixing board 212 with the other end thereof resisting against the corresponding blocking portion 214. Two opposite side edges of one end of the fixing plate 231 extend towards the socket part 202 and slant towards each other to form a pair of elastic arms 232 located in the corresponding fastening groove 213. A pair of contact portions 233 is formed at free ends of the pair of elastic arms 232 and further protrudes face-to-face to form a pair of fastening blocks 234. Each pair of the contact portions 233 is restricted in one group of the restricting grooves 226 and apart exposed in one corresponding inserting slot 224 for electrically clamping the corresponding insertion pin 111 of the charging body 10 therebetween. The fastening blocks 234 of each electrical terminal 203 are buckled in the fastening hole 113 of the corresponding insertion pin 111 for ensuring a steady connection of the charging body 10 and the power plug 20 when plugging the charging body 10 to the power plug 20.

As described above, the charger 100 includes the charging body 10 and the power plug 20 capable of being removably attached to the charging body 10 by means of plugging the insertion pins 111 of the charging body 10 into the corresponding inserting slots 224 of the socket part 202 to electrically clamp the insertion pin 111 between the contact portions 233 of the corresponding electrical terminal 203 respectively. So, when users go abroad, they just need to displace the power plugs 20 of the corresponding countries to plug the charging body 10 thereto so as to use the charging body 10 in different countries. It brings convenience for the users.

The foregoing description of the present invention has been presented for the purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A charger, comprising:
a charging body having a base body and two insertion pins apart assembled to a front end of the base body and further projecting beyond the front end of the base body, at least one USB port being equipped in a rear end of the base body; and
a power plug including a plug part, a socket part mounted to the plug part, and two electrical terminals located between the socket part and the plug part, the plug part having a group of power pins of which one end electrically connects with the electrical terminals and the other end projects outward for plugging in a wall socket, the socket part defining a pair of inserting slots corresponding to the insertion pins of the charging body for plugging the insertion pins of the charging body therein, each electrical terminal having a pair of contact portions which are apart exposed in one of the inserting slots;
wherein the power plug is capable of being removably attached to the charging body by means of plugging the insertion pins of the charging body into the corresponding inserting slots of the socket part to electrically clamp the insertion pin between the contact portions of the corresponding electrical terminal respectively.

2. The charger as claimed in claim 1, wherein each of the electrical terminals has a fixing plate fixed on the plug part and electrically connecting with the corresponding power pin, two opposite side edges of one end of the fixing plate extend towards the socket part and slant towards each other to form a pair of elastic arms, each pair of contact portions are formed at free ends of the pair of elastic arms and further protrude face-to-face to form a pair of fastening blocks, a fastening hole is opened at a front end of each insertion pin of the charging body for buckling the fastening block of the electrical terminal therein when plugging the charging body to the power plug.

3. The charger as claimed in claim 2, wherein the plug part includes a fixing board with a group of fastening grooves being apart defined on an inner side of the fixing board, the inner side of the fixing board further defines a group of blocking portions arranged in accordance with the fastening grooves, the power pins are assembled to the fixing board and further project beyond an outer side of the fixing board, the fixing plate is fixed on the inner side of the fixing board with the other end thereof resisting against the corresponding blocking portion, each pair of elastic arms are located in the corresponding fastening groove.

4. The charger as claimed in claim 2, wherein the socket part includes a base pedestal engaged with the plug part, and a socket body protruding towards a direction opposite to the plug part on the base pedestal, the inserting slots are opened in a rear of the socket body, the interior of the socket body defines two groups of restricting grooves of which each group are spaced from each other and aligned with one of the inserting slots for restricting the pair of contact portions of the corresponding electrical terminal therein.

5. The charger as claimed in claim 4, wherein a rear face of the socket body is concaved forward to form a holding cavity with the inserting slots being opened in a front sidewall thereof, a front of the base body of the charging body is held in the holding cavity when plugging the charging body to the power plug.

6. The charger as claimed in claim 5, wherein a rear end of a top wall of the holding cavity is opened to form an opening for the convenience of taking out the charging body from the power plug.
